(19) United States
(12) Patent Application Publication
(10) Pub. No.: US 2006/0010189 A1
(43) Pub. Date: Jan. 12, 2006

(54) METHOD OF CALCULATING FFT

(76) Inventor: WEI-SHUN LIAO, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 11/160,690

(22) Filed: Jul. 6, 2005

(30) Foreign Application Priority Data
Jul. 12, 2004 (TW) 093120800

(51) Int. Cl. G06F 15/00

(52) U.S. Cl. 708/404

(57) ABSTRACT

The method makes input data of length L correspond to a sequence of data having length M, calculates an exponent N such that a radix to the power of the exponent N is equal to the length M, bit-reverses the indexes of the sequence of data to derive a sequence of data having bit-reversed indexes, calculates an array of weighting factors W[z] according to the exponent N and the length M, loop-calculates the sequence of data having bit-reversed indexes by multiple loop parameters and the array of weighting factors W[z], and outputs the loop-calculating results as FFT values for the input data of length L.

### BACKGROUND OF THE INVENTION

1. Field of the Invention

The present invention relates to a method of calculating an FFT, and more particularly, to calculating an FFT for input data of arbitrary length.

2. Description of the Prior Art

The Butterfly structure is an algorithm that is commonly used to implement an FFT calculation. The algorithm can obtain the results of an FFT calculation by performing multi-level and cross calculations on input data. Please refer to FIG. 1, which shows a well-known Butterfly structure for FFT calculation. In FIG. 1, there are eight fixed input data items, x(0), x(1), x(2), . . . , x(7), which are used to calculate the FFT and get the output results of FFT as X(0), X(1), X(2), . . . , X(7). First, the input order of the eight data items must be determined by the indexed bit-reversal process. The indexed bit-reversal process is the reversal of the index of each input data item from Least Significant Bit order to Most Significant Bit order. For example, index “4” is originally represented by “100” in binary, and it is represented as “001” (index “1”) after the bit-reversal process. Index “6” is represented as “110” in binary, and it becomes index “3” after bit-reversal process as “011” in binary. Index “0” is still index “0” after the reversal, and so on. Therefore, the eight input data, x(0), x(1), x(2), . . . , and x(7), become x(0), x(4), x(2), x(6), x(1), x(5), x(3), and x(7) as shown in FIG. 1 after the rearrangement by the bit-reversal process, and these outputs will be the inputs to the Butterfly structure of the FFT calculation.

Next, the algorithm takes one pair of data items at a time to cross-calculate them. As shown in FIG. 1, x(0) with x(4), x(2) with x(6), x(1) with x(5), and x(3) with x(7) are respectively cross-calculated. During these cross-calculations, x(4), x(5), x(6), and x(7) are multiplied by a weighting factor, W[z], which is also called a twiddle factor, and the derived results of these calculations are x′(0), x′(1), x′(2), . . . , x′(7). Deriving x′ from x is the first-level calculation of the Butterfly structure. Next, x′(0) and x′(2), x′(1) and x′(3), x′(4) and x′(6), and x′(5) and x′(7) are calculated in pairs. Furthermore, during these cross-calculations, x′(2), x′(3), x′(6), and x′(7) are multiplied by the weighting factor W[z] to derive x″(0), x″(1), x″(2), . . . , x″(7). Deriving x″ from x′ is the second-level calculation of the Butterfly structure. Last, x″(0) and x″(4), x″(1) and x″(5), x″(2) and x″(6), and x″(3) and x″(7), are cross-calculated, and x″(4), x″(5), x″(6), and x″(7) are multiplied by the weighting factor W[z] during the cross-calculation to derive the last FFT outputs, which are X[0], X[1], X[2], . . . , X[7]. Deriving X from x″ is the third-level calculation of the Butterfly structure.

The eight input data items mentioned above require three levels of calculations for the Butterfly structure. In fact, more input data items require more levels of calculation of the Butterfly structure. If there are input data of length M, where M=2^{N}, the M input data items require N levels of calculation. For example, 8 is 2³, so eight data items require three levels of calculation, while 16 is 2⁴, so sixteen data items require four levels of calculation.

Among all prior-art methods, these methods can only operate on data of fixed length when processing inputs for an FFT calculation. Moreover, the length of the input data must be constrained to be a power of 2 so as to carry out later calculations. The requirement for a fixed number of input data items causes inconvenience and makes the FFT calculations less flexible. Otherwise, it requires N stages of calculations of the Butterfly structure to derive the results of the calculations for input data of length M, where M is 2 to the power N. In other words, it requires N iterations of the loop to complete the calculations when writing a program to execute the method, making the derived program more complex and lengthy.

### SUMMARY OF THE INVENTION

It is therefore the primary objective of the claimed invention to provide a method for the FFT calculation which loads and calculates data of arbitrary length in a single processing unit, to solve the above problem.

According to a preferred embodiment of the claimed invention, a method comprises making input data of length L correspond to a sequence of data having length M, calculating an exponent N such that a radix to the power of the exponent N is equal to the length M, bit-reversing the indexes of the sequence of data to derive a sequence of data having bit-reversed indexes, calculating an array of weighting factors W[z] according to the exponent N and the length M, loop-calculating the sequence of data having bit-reversed indexes by multiple loop parameters and the array of weighting factors W[z], and outputting the loop-calculating results as FFT values for the input data of length L.

Furthermore, according to a preferred embodiment of the present invention, a Fast Fourier Transform (FFT) device for calculating an FFT for input data of length L is disclosed. The device comprises: a zero-padding module that accepts the data of length L and makes the data of length L correspond to a sequence of data having length M; an exponent-calculating module that calculates an exponent N such that a radix to the power of the exponent N is equal to the length M; a bit-reversal module that accepts the sequence of data and bit-reverses the indexes of the sequence of data by the value of the exponent N to generate a sequence of data having bit-reversed indexes; a factor-calculating module that calculates an array of weighting factors W[z] according to values of the exponent N and the length L; a loop-control module that provides multiple loop parameters according to the exponent N and at least one counter; and a Fourier Transform module that loop-calculates the sequence of data having bit-reversed indexes according to the weighting factors W[z] and the multiple loop parameters, and outputs FFT values for the input data of length L.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of the Butterfly structure of a prior-art FFT.

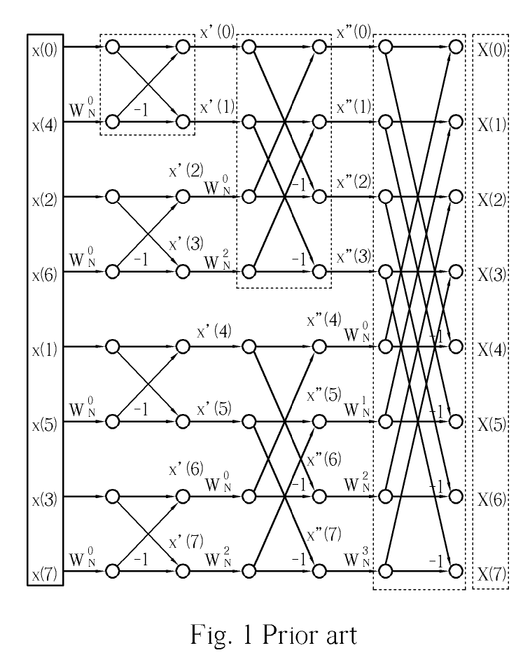

FIG. 2 is a flowchart of the FFT calculation for input data of arbitrary length according to the present invention.

FIG. 3 is a diagram of an FFT device for implementing the FFT calculations with input data of arbitrary length according to the present invention.

### DETAILED DESCRIPTION

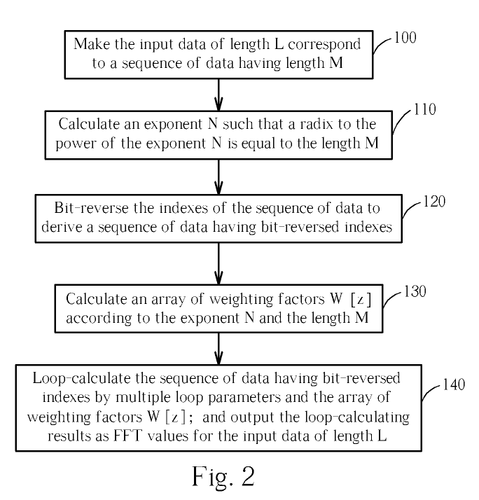

Please refer to FIG. 2, which is a flowchart of the method of the present invention, which performs an FFT calculation on data of arbitrary length. The process can be written as a program to produce FFT outputs. It can be applied to the analysis of frequency spectrum for mobile units in WLAN or a frequency spectrum analyzer to analyze signals. In Step 100, input data of length L is padded at the end with enough zeroes to generate one sequence of data of length M. In Step 110, a logarithm N is calculated such that N=log₂M. The essence of the present invention is that the user can input data of some arbitrary length L, which is not necessarily a power of 2. But for smooth FFT calculations, the input data of length L must be padded with enough zeroes to generate a sequence of length M, which is a power of 2 (2^{N}=M). If L is a power-of-2 number, it will be equal to the value of M (2^{N}=L=M). Else, if L is not a power-of-2 number, M will be the next largest power of 2 number that is greater than L (2^{N-1}<L<M=2^{N}). The sequence of length M is generated by padding the input data of length L with zeroes of length (M−L).

In Step 120, bit-reversal is performed on indexes of the sequence of data to derive a sequence of data items with bit-reversed indexes. Bit-reversal means reversing the bit order of the indexes of the data items from Least Significant Bit to Most Significant Bit. In Step 130, an array of weighting factors W[z] (twiddle factor), which is an array, are calculated from the values of N and M. The weighting factor W[z] is a necessary variable in the FFT calculation and is related to the length of the input data and the logarithm of the length. Please note that the weighting factor W[z] is already well-known by those skilled in the art and thus omitted here. In Step 140, the sequence of data items with bit-reversed indexes is calculated in loops by W[z] and multiple loop parameters, and it returns the FFT values as output results of the procedure. During this procedure, three levels of loop calculation are implemented. The multiple loop parameters include i, j, k, and FFA_radix. The index i is used to control the number of execution times of the outermost level, while indexes j, k are used to control the number of executions of the second level and the innermost level. FFA_radix is also a control variable. The values of i are 0, 1, . . . , (j−1), while the values of j are 0, 1, . . . , (M/2)−1. The sequence of data with the bit-reversed indexes are x[0], x[1], . . . , x[M−1]. FFA_radix is a variable whose value is a power of 2. During the first time (i=1) executing the outermost loop, the value of FFA_radix is 2. Each time thereafter, FFA_radix doubles the outermost loop is executed. Thus, each time the outermost loop is executed corresponds to a particular value of FFA_radix. During each time the outermost level of loop is executed, i remains fixed while k increases from 0 to FFA_radix by 1 (FFA_radix corresponds to the i value when it is executed). During each time the outermost level of loop is executed, if k is smaller than half of the corresponding FFA_radix (k<0.5*FFA_radix), then the equation
x[FFA_{—}radix*j+k]=x[FFA_{—}radix*j+k]+x[FFA_{—}radix*j+k+FFA_{—}radix/2]*W[z]
will be executed. If k is not smaller than half of the corresponding FFA_radix (k≧0.5* FFA_radix), then the equation
   x[FFA_{—}radix*j+k]=x[FFA_{—}radix*j+k]*W[z]+x[FFA_{—}radix*j+k−FFA_{—}radix/2]
will be executed.

The detailed code is listed below to explain Step 140 more precisely.

FFA_pts=M;
FFA_radix=1;
for( i=0; i<N; i++)
{

FFA_pts/=2;
FFA_radix*=2;
for( j=0; j<FFA_pts; j++)
{

for( k=0; k<FFA_radix; k++)
{

if(k<FFA_radix/2)

x[FFA_radix*j+k]=x[FFA_radix*j+k]+x[FFA_radix*j+k+FFA_radix/2]*W[k*FFA_pts];

else

x[FFA_radix*j+k]=x[FFA_radix*j+k]*W[k*FFA_pts]+ x[FFA_radix*j+k−FFA_radix/2];

}

}
for ( k=0; k<FFT_pts; k++) x[k]=X[k];

}

This program is explained as follows. As mentioned before, the outermost loop is controlled by i, which increases by 1 from 0 to N−1. In the beginning, the factor FFA_pts is set to M, which is the length of the input data, and FFA_radix is set to 1. Every time the outermost level of loop is executed, FFA_pts will halve, while FFA_radix doubles. Therefore, the values of FFA_pts and FFA_radix will be different for all values of i. The second level of loop is controlled by j, which increases from 0 to FFA_pts by 1, where FFA_pts is related to i each time the outermost loop is executed. The innermost loop is controlled by k. k increases from 0 to FFA_radix-1 by 1 where the value of FFA_radix corresponds to i. In the innermost loop, if k is smaller than half of the corresponding FFA_radix (k<0.5*FFA_radix), then the equation
x[FFA_{—}radix*j+k]=x[FFA_{—}radix*j+k]+x[FFA_{—}radix*j+k+FFA_{—}radix/2]*W[z]
will be executed. If k is not smaller than half of the corresponding FFA_radix (k≧0.5*FFA_radix), then the equation
   x[FFA_{—}radix*j+k]=x[FFA_{—}radix*j+k]*W[z]+x[FFA_{—}radix*j+k−FFA_{—}radix/2]
will be executed. The array of outputs X[z] of this program are the results of the FFT calculation by inputting data of length L.

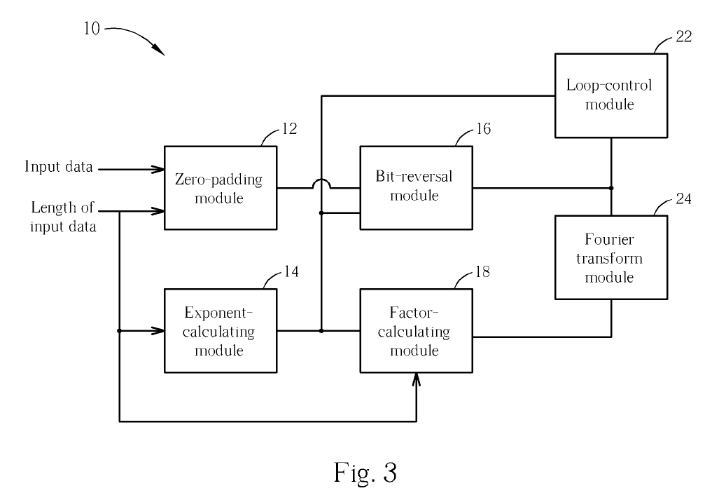

Please refer to FIG. 3, which shows an FFT device 10 used for the FFT calculations for input data of length L. The FFT device 10 is a processing device for performing the FFT calculation. The FFT device 10 comprises a zero-padding module 12, a logarithm-calculating module 14, a bit-reversal module 16, a factor-calculating module 18, a loop-control module 22, and a fourier transform module 24. The zero-padding module 12 is used to pad the data of length L at the end with enough zeroes to generate a sequence of data of length M. The logarithm-calculating module 14 will calculate a logarithm N of M such that 2^{N}=M. If L happens to be a power of 2, then L is equal to M (2^{N}=L=M). Otherwise, if L is not a power of 2, M will be the smallest power-of-2 value that is greater than L (2^{N-1}<L<M=2^{N}). The sequence of data of length M is generated by padding the input data of length L at the end with zeroes of length (M−L). The bit-reversal module 16 accepts this sequence of data items and bit-reverses its indexes according to N to generate a sequence of data items with the bit-reversed indexes. Bit-reversal means reversing the order of the indexes of the data items inside the sequence from Least Significant Bit to Most Significant Bit. Inside the factor-calculating module 18, an array of weighting factors W[z] (also called twiddle factors) are calculated by the values of N and M. The loop-control module 22 controls the four loop variables i, j, k, and FFA_radix inside the three loops of FFT, by the value of N and at least one counter. As mentioned above, the index i is used to control the number of execution times of the outermost level of the for-loop, while j and k are used to control the number of executions of the second level and the innermost level of for-loops. FFA_radix is a self-doubling control variable. The range of i is 0, 1, . . . , (j−1), while the range of j is 0, 1, . . . , (M/2)−1. The sequence of data items with the bit-reversed indexes are x[0], x[1], . . . , x[M−1]. FFA_radix is a control variable whose value is a power of 2. During the first time (i=1) executing the outermost level of for-loop, the value of FFA_radix is 2. Thereafter, FFA_radix doubles each time the outermost level of the for-loop is executed. Each execution of the outermost level of for-loop corresponds to some value of FFA_radix. The index k ranges in value between 0 and FFA_radix during each execution of the outermost level of the for-loop and increases from 0 to FFA_radix by 1 (FFA_radix corresponds to the value of i). The Fourier transform module 24 will output FFT values based on the input data of length L according to the loop-operations on weighting factors W[z] and the multiple loop parameters. The loop operations include running loop operations in Step 140 of FIG. 2.

Among all prior-art methods, when processing input data with FFT, only calculations on data of particular length can be performed. Moreover, this length must be a power of 2. The constraint for data of a particular length causes inconvenience in usage and makes the FFT calculations less flexible. Besides, for data of length M, where N=log₂M, it takes N stages of the Butterfly structure to derive the results of FFT calculations. In other words, it takes N stages for the program to complete the whole calculation, that makes the program more lengthy and complex.

In contrast to the prior art, the present invention can transform data of arbitrary length to a sequence of data items whose length is a power of 2 so that the present invention can handle FFT calculations for variable length of input data. In addition, it takes only three levels of loops to complete the FFT calculations no matter what the size of the input data, therefore giving the advantages of simple calculation, high efficiency, and lower hardware requirements.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for Fast Fourier Transform (FFT) calculation performed by a processing unit to calculate an FFT for input data of length L, the method comprising:
making the input data of length L correspond to a sequence of data having length M;
calculating an exponent N such that a radix to the power of the exponent N is equal to the length M;
bit-reversing the indexes of the sequence of data to derive a sequence of data having bit-reversed indexes;
calculating an array of weighting factors W[z] according to the exponent N and the length M;
loop-calculating the sequence of data having bit-reversed indexes by multiple loop parameters and the array of weighting factors W[z]; and
outputting the loop-calculating results as FFT values for the input data of length L.

2. The method of claim 1 further comprising:
if the length L of the input data is less than length M, padding the input data with a series of zeros to make the sequence of data have length M.

3. The method of claim 1, wherein the radix is two.

4. The method of claim 1, wherein the step of loop-calculating comprises three levels of loop; and the multiple loop parameters comprise a control variable i for an outermost level of loop, a control variable j for a second level of loop, a control variable k for an innermost level of loop, and a control variable FFA_radix that doubles each time the outermost level of loop is executed.

5. The method of claim 4, wherein the control variable i is an integer that increases by one from zero to exponent N minus one; the control variable j is an integer that increases by one from zero to half of length M minus one; the sequence of data having bit-reversed indexes comprises values x indexed from zero to length M minus one; the control variable FFA_radix is a power of two; and the control variable k is an integer that increases by one from zero to the value of the control variable FFA_radix during a single execution of the outermost level of the loop.

6. The method of claim 5, wherein during a single execution of the outermost level of loop, if the control variable k is smaller than half of the corresponding value of the control variable FFA_radix, then the sequence of data having bit-reversed indexes is determined by:
x[FFA_{—}radix*j+k]=x[FFA_{—}radix*j+k]+x[FFA_{—}radix*j+k+FFA_{—}radix/2]*W[z].

7. The method of claim 5, wherein during single execution of the outermost level of loop, if the control variable k is not smaller than half of the corresponding value of the control variable FFA_radix, then the sequence of data having bit-reversed indexes is determined by:
x[FFA_{—}radix*j+k]=x[FFA_{—}radix*j+k]*W[z]+x[FFA_{—}radix*j+k−FFA_{—}radix/2].

8. The method of claim 1, wherein the step of bit-reversing comprises:
from least significant bit to most significant bit, reversing the order of indexes of the sequence of data to derive the sequence of data having bit-reversed indexes.

9. A Fast Fourier Transform (FFT) device for calculating an FFT for input data of length L, the device comprising:
a zero-padding module that accepts the data of length L and makes the data of length L correspond to a sequence of data having length M;
an exponent-calculating module that calculates an exponent N such that a radix to the power of the exponent N is equal to the length M;
a bit-reversal module that accepts the sequence of data and bit-reverses the indexes of the sequence of data by the value of the exponent N to generate a sequence of data having bit-reversed indexes;
a factor-calculating module that calculates an array of weighting factors W[z] according to values of the exponent N and the length L;
a loop-control module that provides multiple loop parameters according to the exponent N and at least one counter; and
a Fourier Transform module that loop-calculates the sequence of data having bit-reversed indexes according to the weighting factors W[z] and the multiple loop parameters, and outputs FFT values for the input data of length L.

10. The device of claim 9, wherein the radix is two.

11. The device of claim 9, wherein the length L is equal to the length M.

12. The device of claim 9, wherein if the length M is greater than the length L, the zero-padding module generates the sequence of data of length M by padding the data of length L with zeros.

13. The device of claim 9, wherein loop-calculation of the Fourier Transform module includes three levels of loop; and the multiple loop parameters comprise a control variable i for an outermost level of loop, a control variable j for a second level of loop, a control variable k for an innermost level of loop, and a control variable FFA_radix that doubles each time the outermost level of loop is executed.

14. The device of claim 13, wherein the control variable i is an integer that increases by one from zero to exponent N minus one; the control variable j is an integer that increases by one from zero to half of length M minus one; the sequence of data having bit-reversed indexes comprises values x indexed from zero to length M minus one; the control variable FFA_radix is a power of two; and the control variable k is an integer that increases by one from zero to the value of the control variable FFA_radix during a single execution of the outermost level of the loop.

15. The device of claim 14, wherein during a single execution of the outermost level of loop, if the control variable k is smaller than half of the corresponding value of the control variable FFA_radix, then the sequence of data having bit-reversed indexes is determined by:
x[FFA_{—}radix*j+k]=x[FFA_{—}radix*j+k]+x[FFA_{—}radix*j+k+FFA_{—}radix/2]*W[z].

16. The device of claim 14, wherein during single execution of the outermost level of loop, if the control variable k is not smaller than half of the corresponding value of the control variable FFA_radix, then the sequence of data having bit-reversed indexes is determined by:
x[FFA_{—}radix*j+k]=x[FFA_{—}radix*j+k]*W[z]+x[FFA_{—}radix*j+k−FFA_{—}radix/2].

17. The device of claim 9, wherein the bit-reversal module reverses the order of indexes of the sequence of data from least significant bit to most significant bit to derive the sequence of data having bit-reversed indexes.
